(19) United States
(12) Patent Application Publication
(10) Pub. No.: US 2022/0286922 A1
(43) Pub. Date: Sep. 8, 2022

(54) METHOD, AND BASE STATION

(71) Applicant: NEC Corporation, Minato-ku, Tokyo (JP)

(72) Inventors: Yuhua CHEN, Surrey (GB); Sadafuku HAYASHI, Tokyo (JP); Jagdeep Ahluwalia SINGH, Surrey (GB); Chadi KHIRALLAH, Surrey (GB)

(73) Assignee: NEC Corporation, Minato-ku, Tokyo (JP)

(21) Appl. No.: 17/628,628

(22) PCT Filed: Oct. 2, 2020
(86) PCT No.: PCT/JP2020/037632

§ 371 Date: Jan. 20, 2022

(30) Foreign Application Priority Data
Oct. 4, 2019 (GB) 1914404.7

(51) Int. Cl. H04W 36/00; H04W 36/08; H04W 76/19; H04W 76/30; H04W 76/20

(52) U.S. Cl. CPC H04W 36/0061; H04W 36/0033; H04W 36/08; H04W 76/19; H04W 76/30; H04W 76/20

(57) ABSTRACT

In one aspect, a method performed by a base station in a Non-Public Network includes: operating a closed access group (CAG) cell; establishing a communication connection with a user equipment (UE) in the CAG cell, wherein the CAG cell is associated with a CAG having an associated CAG identifier; suspending the communication connection; receiving, from a further base station, a first message indicating that the UE has requested resumption of the communication connection in a CAG cell operated by the further base station, the first message including a CAG identifier of a CAG which the CAG cell operated by the further base station is associated with; performing CAG membership verification for the CAG identified by the CAG identifier in the first message; and sending, to the further base station, a second message indicating a result of the CAG membership verification.

### TECHNICAL FIELD

The present disclosure relates to a communication system.

### BACKGROUND ART

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced and Next Generation or 5G networks). The disclosure has particular, although not necessarily exclusive relevance to Non-Public Networks (NPNs) that may be deployed with the support of PLMNs (Public Land Mobile Networks using Closed Access Group (CAG) and/or network slicing.

The latest developments of the 3GPP standards are referred to as the Long Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the base station via which communication devices (user equipment or ‘UE’) connect to a core network and communicate to other communication devices or remote servers. For simplicity, the present application will use the term base station to refer to any such base stations.

In the current 5G architecture, for example, the gNB internal structure is split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), PDCP) and the, typically ‘lower’, DU layers (for example, but not necessarily or exclusively, RLC/MAC/PHY) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term mobile device, user device, or UE to refer to any communication device that is able to connect to the core network via one or more base stations.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

The core network (i.e. the EPC in case of LTE) typically hosts functionality for subscriber management, mobility management, charging, security, and call/session management (amongst others), and provides connection for communication devices to external networks, such as the Internet.

Communication between mobile devices and base stations is controlled using a Radio Resource Control (RRC) protocol as defined in 3GPP TS 36.331 V15.7.0 (for E-UTRA) and 3GPP TS 38.331 V17.1.0 (for NR). RRC handles the control plane signalling of Layer 3 between mobile telephones and the radio access network, and includes, amongst other things, functions for broadcasting system information, paging, connection establishment and release, radio bearer establishment, reconfiguration and release, mobility procedures, and power control. In accordance with the current version of the RRC protocol, at any given time, a mobile device may operate either in an ‘RRC idle mode’ (in which no data communication takes place) or an ‘RRC connected mode’ (in which data communication may take place between the mobile device and its serving base station).

As mobile devices operating in the RRC connected mode move around in the area covered by the communication system, they are handed over from one cell (i.e. operated by a base station) to another cell (operated by the same or a different base station), depending on signal conditions and other requirements, such as requested quality of service, the type of service used, overall system load, and the like. Handover requires extensive signalling between the mobile device and the base stations (old and new) and also between the base stations and the core network as well.

On the other hand, whilst in the RRC idle mode, mobile devices are programmed to select a ‘serving’ cell, having a good quality signal, to camp on so that when new data is to be transmitted to/from these mobile devices, they can benefit from favourable signal conditions. In the event that an idle mobile device detects a new cell with better signal quality than the current serving cell, e.g. due to the mobile device changing its location, the mobile device can perform a so-called cell reselection procedure. However, an idle mode mobile device does not inform the network about the selected new cell as long as this cell is within the same ‘tracking area’ (i.e. a larger geographic area comprising a pre-defined set of cells), because the radio network transmits system information and UE specific paging messages within the whole tracking area thus making it possible to initiate communication to/from the mobile device regardless of the current cell it camps on.

In order to benefit from the lowest energy consumption and to free up valuable system resources, the mobile devices return to the RRC idle mode whenever possible and perform cell reselections (instead of handovers) as long as they remain within the same tracking area. The base station controls the transition between the various operating modes for each mobile device within its cell(s). Since the setting up and termination of an RRC connection between the base station and the mobile device requires exchanging of signalling messages and hence utilises valuable system resources, and also takes some time to complete, the transition from connected to idle mode is allowed under specific circumstances as defined in 3GPP TS 36.331. For example, the serving base station might instruct a mobile device to enter the RRC idle mode only after it has confirmed that there is no more data to be transmitted to/from the particular mobile device (e.g. both uplink (UL) and downlink (DL) buffers are empty).

When it registers its current location (e.g. cell) with the core network, each mobile device also has an associated ‘S1’ connection between its serving base station and the core network. The S1 connection is either in a so-called ‘ECM-IDLE’ mode (when the mobile device is in RRC idle mode) or in an ‘ECM-CONNECTED’ mode (when the mobile device is in RRC connected mode). The S1 connection is used for transferring data (control and user data) between the mobile device and the core network (and beyond) and it is maintained as long as the mobile device remains in the RRC connected mode. On the other hand, when a mobile device enters the RRC idle mode, its associated S1 connection is also terminated (or suspended) until the mobile device has more data to send or receive in which case a new S1 connection is established to the current serving base station (or the suspended S1 connection is re-activated).

When the network has data to send to an RRC idle mobile device, it triggers an appropriate paging procedure in the last known area (tracking/paging area) of the mobile device, which causes the base stations within that area to broadcast appropriate paging messages in their cells requesting that particular mobile device to enter the RRC connected state. When a previously idle mobile telephone has data to send again (or it has been paged for receiving downlink data), in order to be allocated communication resources it initiates a so called RRC connection establishment procedure by sending an appropriately formatted RRC connection request message to the base station (following a so-called Random Access Procedure which ensures that the lower layers, and in particular the Media Access Control (MAC) layer, are set up for communication with the base station).

For the latest developments of the 3GPP standards, the so-called Next Generation (NG) or 5G networks, it is envisaged that mobile devices may also operate in a new RRC state, or new radio state, referred to as an ‘RRC inactive’ state (e.g. in 5G), or a ‘light-connected’ (LC) state/mode (e.g. in LTE/4G). When a mobile device is in the RRC inactive state, the core network maintains both its control-plane and user-plane connection even after the mobile device has no more data to send or receive (and hence it is normally configured to enter the RRC idle mode). In other words, even though in the RRC inactive state/mode the mobile device is seen as operating in idle mode from the radio access network's (base station's) point of view, it may still be seen as being connected from the core network's point of view (even though there is no active RRC connection (i.e. SRB/DRB) between the base station and the RRC inactive state UE). One of the benefits of this new RRC inactive state/mode is that mobile devices (IoT devices in particular) that have small and infrequent data transmissions do not need to perform the entire RRC connection establishment procedure every time they have data to send (or receive). Instead, an RRC inactive state/mode capable mobile device can be configured to resume its existing RRC connection with the current serving base station whenever needed and then return to a more power efficient mode of operation until it has data to send/receive again.

The mobile device can resume its RRC connection by sending to its current base station information (e.g. a resume ID) identifying the connection to be resumed. This beneficially avoids the base station and the mobile device having to go through authentication and radio bearer establishment. In order to facilitate such lightweight connection and simplified resumption of the connection between the mobile device and its serving base station, the concept of a so-called anchor base station is being considered by 3GPP.

In 5G, for example, a concept known as RAN-based Notification Area (RNA) is supported. When a UE moves out of the RNA cell list, it needs to report its location change (similar to the TAU concept in LTE) which is called RAN-based notification area update (RNAU). When a UE is in the RRC_INACTIVE mode, it cannot automatically trigger a RNAU to enable the ‘anchor’ or last serving gNB to determine whether or not there has been a location change. Therefore, this procedure is typically triggered periodically by the (currently) serving ng-eNB or gNB which sends a I-RNTI and an appropriate cause value, i.e. RNAU.

When the mobile device attempts to resume its RRC connection via a different base station (within the same area), in a RNAU or TAU procedure, the new base station can contact the anchor base station and retrieve the UE context along with the cached user data based on information provided by the mobile device (e.g. resume ID and/or the like). Since in the RRC inactive state/mode the S1 connection is maintained, beneficially, the new base station can avoid having to contact the core network and/or establish a new S1 connection for the mobile device (although the new base station might need to switch the S1 connection from the anchor/previous base station to the new base station). This procedure may be referred to as anchor relocation and it involves switching an S1 terminating point from an Anchor base station to a new Serving base station whilst transferring the UE context.

In an alternative scenario, the RNA update procedure may occur without UE context relocation. In other words, the UE may attempt to resume its RRC connection via a new, gNB different to the last serving gNB, and a RNAU procedure may be performed without UE context relocation. In other words, the UE context may remain at the last serving (or ‘anchor’) gNB, even though the new base station sends the RRCRelease signal to transition the UE back to RRC_INACTIVE mode. In this case, and with reference to the timing diagram of FIG. 12 reproduced from 3GPP TS 38.300 V15.7.0, the UE resumes and provides the I-RNTI allocated by the last serving gNB and the appropriate cause value (e.g. RAN Notification Area Update) to the new gNB using the RRCResumeRequest message. Next, if the new gNB is able to resolve the gNB identity contained in the I-RNTI, it requests the last serving gNB to provide the UE Context using a RETRIEVE UE CONTEXT REQUEST message including RNA Update information. Upon receipt of the RETRIEVE UE CONTEXT REQUEST message, the last serving gNB stores the received information to be used in the next UE resume attempt and returns a RETRIEVE UE CONTEXT FAILURE message including an encapsulated RRCRelease message which includes a Suspend Indication message. Finally, the new gNB forwards the RRCRelease message to the UE, which then transitions back to RRC_INACTIVE mode until the next resume event.

### SUMMARY OF INVENTION

### Technical Problem

All of the above concepts apply to networks supported by PLMNs. However, in addition, the current 3GPP agreement accommodates the concept of Non-Public Networks (NPNs). A NPN is defined as a network that is intended for non-public use, and is discussed in detail in 3GPP TS 22.261 V17.0.1, Service Requirements for the 5G System. In other words, a NPN is intended for the sole use of a private entity such as an enterprise or organisation and may be deployed in a variety of configurations, utilising both virtual and physical elements. Specifically, an NPN may be deployed as described in 3GPP TS 23.501 V16.2.0 in more detail:
a Stand-alone Non-Public Network (SNPN), i.e. operated by an NPN operator and not relying on network functions provided by a PLMN, or
a Public Network integrated NPN (PNI-NPN), i.e. a NPN deployed with the support of a PLMN.

SNPN 5GS deployments are based on the architecture depicted in 3GPP TS 23.501, clause 4.2.3, and the additional functionality covered in clause 5.30.2.

PNI-NPN can be enabled using network slicing (see Annex D of 3GPP TS 23.501). To prevent unauthorized UEs from trying to access a PNI-NPN, the Closed Access Group (CAG) functionality described in clause 5.30.3 of 3GPP TS 23.501 can also be used.

In more detail, CAG Access Control is used to enable NPNs to be deployed as part of a PLMN. When a UE accesses a CAG cell, the network needs to verify whether the UE is allowed to access the CAG cell. This is also known as UE CAG membership verification. A CAG identifies a group of subscribers who are permitted to access one or more CAG cells. When the UE accesses the CAG cell, the network needs to verify whether the UE is allowed to access the CAG cell.

However, for the network to verify a UE's access to a CAG cell, it needs to know the UE's SUPI (Subscription Permanent Identifier). During the initial NAS (Non Access Stratum) procedure (i.e. the Registration Procedure), the UE sends its Subscription Concealed Identifier (SUCI) to the network. The serving network receives the UE's SUPI from an AUSF (authentication Server Function), only after successful primary authentication. Following the primary authentication process, whereby a UE is registered with the network, a similar authentication or ‘membership verification’ process needs to be performed every time a UE's state transitions from RRC Idle or RRC Inactive to RRC live (for example, in the case of a periodic RNAU of the type described above) and also in the case of UE context relocation, when a UE requests a new ‘serving’ cell. In other words, for state transition and mobility, a membership verification process is required to be performed in order to verify that the CAG Identifier (CAG ID) received from the Radio Access Network (RAN) is part of the UE's allowed CAG list as received from UDM (Unified Data Management function) incorporated in the core network (e.g. EPC in case of LTE or 5GC in case of 5G). One of the principal purposes of such authentication is to prevent UEs without a valid subscription from performing registration procedures to access the network via CAG cells.

Typically, the membership or access verification process described above is performed by the Access and Mobility Function included in the core network, as it is implemented in a module that is located in a physically secure place (usually the location in which the NPN is to be used).

However, the need for a membership/access verification process via the core network each time a base station in RRC_INACTIVE or RRC_IDLE mode resumes for a periodic RNAU update or handover operation, for example, involves extensive additional signalling between the serving base station (and the anchor and/or new serving base stations, where appropriate) and the core network. This, in turn, negates the benefit of the RRC_INACTIVE mode because, even though the RRC connection establishment procedure can be avoided, as described above, the membership verification procedure is required to be performed each time via the core network.

Accordingly, preferred embodiments of the present disclosure aim to provide methods and apparatus which address or at least partially deal with one or more of the above issues, freeing up valuable network resources, whilst still allowing mobile devices to maintain a light/RRC inactive connection with a Non-Public network.

Although for efficiency of understanding for those of skill in the art, the disclosure will be described in detail in the context of a 3GPP system (UMTS, LTE, NR), the principles of the disclosure can be applied to other systems in which communication devices or User Equipment (UE) access a core network using a radio access technology.

### Solution to Problem

In one aspect the disclosure provides a method performed by a base station in a Non-Public communication Network in which the base station operates at least one closed access group (CAG) cell, the method comprising: forming a communications connection with a user equipment (UE) in a CAG cell operated by the base station, wherein the CAG cell is associated with a CAG having an associated CAG identifier; releasing the communications connection for suspension of the connection at the UE; receiving, from a further base station, a message indicating that the UE has requested resumption of the communication connection in a CAG cell operated by the further base station, the message comprising a CAG identifier of a CAG with which the cell operated by the further base station is associated; performing CAG membership verification for the CAG identified by the CAG identifier provided in the message indicating that the UE has requested resumption of the communication connection; and sending a message to the further base station indicating a result of said CAG membership verification.

In one aspect the disclosure provides a method performed by a base station in a Non-Public communication Network in which the base station operates at least one closed access group (CAG) cell, the method comprising: receiving, from a user equipment (UE) in a CAG cell operated by the base station, wherein the CAG cell is associated with a CAG having an associated CAG identifier, a message for resumption of a communication connection suspended in a CAG cell operated by another base station; obtaining, from said another base station or from a core network function, CAG membership information for the CAG associated with the CAG cell operated by that base station; and performing CAG membership verification for the CAG identifier based on the obtained CAG membership information.

In one aspect the disclosure provides a base station for a Non-Public communication Network in which the base station operates at least one closed access group (CAG) cell, the base station comprising a controller and a transceiver wherein the controller is configured: to control the transceiver in the formation of a communications connection with a user equipment (UE) in a CAG cell operated by the base station, wherein the CAG cell is associated with a CAG having an associated CAG identifier; to control the transceiver to release the communications connection for suspension of the connection at the UE; to control the transceiver receive, from a further base station, a message indicating that the UE has requested resumption of the communication connection in a CAG cell operated by the further base station, the message comprising a CAG identifier of a CAG with which the cell operated by the further base station is associated; to perform CAG membership verification for the CAG identified by the CAG identifier provided in the message indicating that the UE has requested resumption of the communication connection; and to control the transceiver to send a message to the further base station indicating a result of said CAG membership verification.

In one aspect the disclosure provides a base station for a Non-Public communication Network in which the base station operates at least one closed access group (CAG) cell, the base station comprising a controller and a transceiver wherein the controller is configured: to control the transceiver to receive, from a user equipment (UE) in a CAG cell operated by the base station, wherein the CAG cell is associated with a CAG having an associated CAG identifier, a message for resumption of a communication connection suspended in a CAG cell operated by another base station; to control the transceiver to obtain, from said another base station or from a core network function, CAG membership information for the CAG associated with the CAG cell operated by that base station; and to performing CAG membership verification for the CAG identifier based on the obtained CAG membership information.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### Advantageous Effects of Invention

According to the present disclosure, it is possible to provide methods and associated apparatus which address or at least partially deal with one or more of the above issues.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a block diagram of a User Equipment (UE) forming part of the system shown in FIG. 1;

FIG. 3 is a block diagram of a base station forming part of the system shown in FIG. 1;

FIG. 4 is a block diagram of a core network node entity forming part of the system shown in FIG. 1;

FIG. 5A illustrates one of block diagrams of two different deployments of a PNI-NPN to which embodiments of the disclosure may be applied;

FIG. 5B illustrates the other of block diagrams of two different deployments of a PNI-NPN to which embodiments of the disclosure may be applied;

FIG. 6 is a timing diagram illustrating an exemplary way in which embodiments of the disclosure can be implemented in the system of FIG. 1; and

FIG. 7 is a timing diagram illustrating an exemplary way in which embodiments of the disclosure can be implemented in the system of FIG. 1; and

FIG. 8 is a timing diagram illustrating an exemplary way in which embodiments of the disclosure can be implemented in the system of FIG. 1; and

FIG. 9 is a timing diagram illustrating an exemplary way in which embodiments of the disclosure can be implemented in the system of FIG. 1; and

FIG. 10A is a timing diagram illustrating an exemplary way in which embodiments of the disclosure can be implemented in the system of FIG. 1; and

FIG. 10B is a timing diagram illustrating an exemplary way in which embodiments of the disclosure can be implemented in the system of FIG. 1; and

FIG. 11A is a timing diagram illustrating an exemplary way in which embodiments of the disclosure can be implemented in the system of FIG. 1;

FIG. 11B is a timing diagram illustrating an exemplary way in which embodiments of the disclosure can be implemented in the system of FIG. 1; and

FIG. 12 is a timing diagram of a typical RNAU procedure without UE context relocation, which may be performed in the system of FIG. 1.

### DESCRIPTION OF EMBODIMENTS

Overview

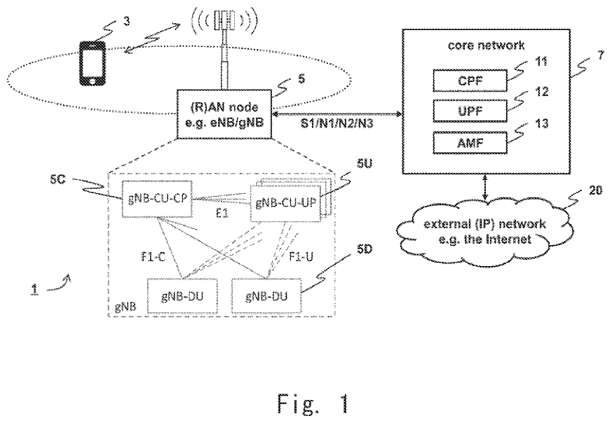

FIG. 1 schematically illustrates a mobile (cellular or wireless) telecommunication system 1 to which embodiments of the present disclosure are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 are shown in FIG. 1 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ‘eNB’ and a base station 5 that supports Next Generation/5G protocols may be referred to as a ‘gNBs’. It will be appreciated that some base stations 5 may be configured to support both 4G and 5G, and/or any other 3GPP or non-3GPP communication protocols.

It will be appreciated that the functionality of a gNB 5 (referred to herein as a ‘distributed’ gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB or RRC and PDCP layers of the En-gNB that controls the operation of one or more gNB-DUs. The gNB-CU terminates the F1 interface connected with the gNB-DU.

gNB Distributed Unit (gNB-DU) 5D: a logical node hosting Radio Link Control (RLC), Medium Access Control (MAC) and Physical (PHY) layers of the gNB or En-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP) 5C: a logical node hosting the RRC and the control plane part of the PDCP protocol of the gNB-CU for an En-gNB or a gNB. The gNB-CU-CP terminates the E1 interface connected with the gNB-CU-UP and the F1-C interface connected with the gNB-DU.

gNB-CU-User Plane (gNB-CU-UP) 5U: a logical node hosting the user plane part of the PDCP protocol of the gNB-CU for an En-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N1’, ‘N2’, ‘N3’ interface, and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) 11 and user plane functions (UPFs) 12. It will be appreciated that the core network 7 may also include, amongst others, an Access and Mobility Management Function (AMF) 13. From the core network 7, connection to an external IP network 20 (such as the Internet) may also be provided.

Mobile Device

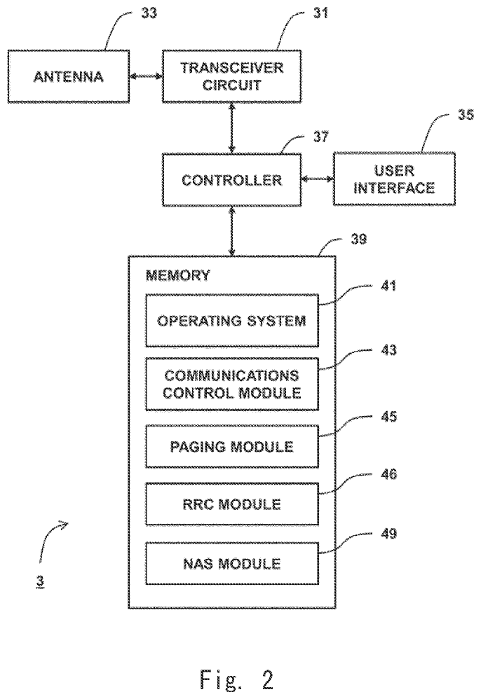

FIG. 2 is a block diagram illustrating the main components of the mobile device 3 shown in FIG. 1 (e.g. a mobile telephone or an IoT device). As shown, the mobile device 3 has a transceiver circuit 31 that is operable to transmit signals to and to receive signals from a base station 5 via one or more antenna 33. The mobile device 3 has a controller 37 to control the operation of the mobile device 3. The controller 37 is associated with a memory 39 and is coupled to the transceiver circuit 31. Although not necessarily required for its operation, the mobile device 3 might of course have all the usual functionality of a conventional mobile telephone (such as a user interface 35) and this may be provided by any one or any combination of hardware, software and firmware, as appropriate. Software may be pre-installed in the memory 39 and/or may be downloaded via the telecommunications network or from a removable data storage device (RMD), for example.

The controller 37 is configured to control overall operation of the mobile device 3 by, in this example, program instructions or software instructions stored within memory 39. As shown, these software instructions include, among other things, an operating system 41, a communications control module 43, a paging module 45, an RRC module 46, and a NAS module 49.

The communications control module 43 is operable to control the communication between the mobile device 3 and its serving base station 5 (and other communication devices connected to the serving base station 5, such as other user equipment, core network nodes, etc.).

The paging module 45 is responsible for maintaining a (RAN based) paging area (e.g. in the form of a list of cells) in which the mobile device 3 can be paged, and to control the transceiver 31 to monitor for paging messages addressed to the mobile device 3. The paging module 45 is also responsible to notify the other modules (e.g. the RRC module 46 and the NAS module 49, as appropriate) when the mobile device 3 is about to leave (or when it has left) the currently configured RAN paging area (for example, in order to perform an appropriate location update procedure).

The RRC module 46 is operable to generate, send and receive signalling messages formatted according to the RRC standard. For example, such messages are exchanged between the mobile device 3 and its serving base station 5. The RRC messages may include, for example, messages relating to configuring a (RAN based) paging area for the mobile device 3.

The NAS module 49 is operable to generate, send and receive signalling messages formatted according to the NAS standard. For example, such messages are exchanged between the mobile device 3 and the MME 13 (via the serving base station 5, using the RRC module 46). The NAS messages may include, for example, messages relating to registering and/or updating a tracking area (or cell) where the mobile device 3 is currently located.

Base Station

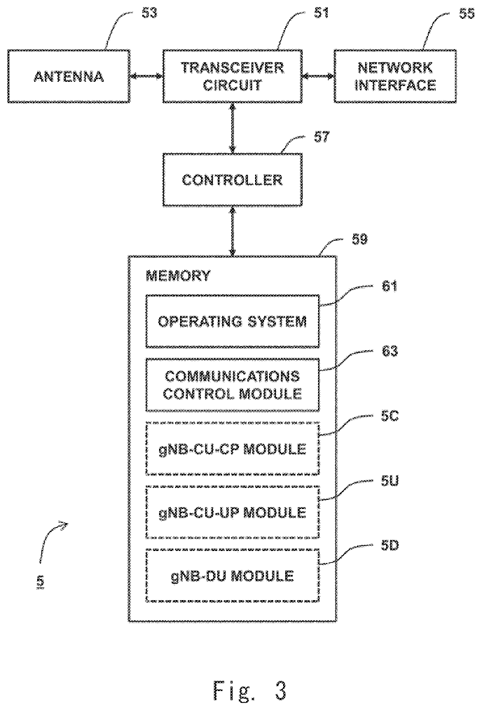

FIG. 3 is a block diagram illustrating the main components of a base station 5 shown in FIG. 1. As shown, the base station 5 has a transceiver circuit 51 for transmitting signals to and for receiving signals from user equipment (such as the mobile device 3) via one or more antenna 53, a core network interface 55 (e.g. an S1 interface, NG-C interface, and/or the like) for transmitting signals to and for receiving signals from the core network 7, and a base station interface 56 (e.g. an X2 interface, Xn interface, and/or the like) for transmitting signals to and for receiving signals from neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63.

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. NAS, RRC, paging, system information, and/or the like).

When the base station 5 comprises a distributed gNB or En-gNB, the network interface 55 also includes an E1 interface and an F1 interface (F1-C for the control plane and F1-U for the user plane) to communicate signals between respective functions of the distributed gNB or En-gNB. In this case, the software also includes at least one of: a gNB-CU-CP module 5C, a gNB-CU-UP module 5U, and a gNB-DU module 5D. If present, the gNB-CU-CP module 5C hosts the RRC layer and the control plane part of the PDCP layer of the distributed gNB or En-gNB. If present, the gNB-CU-UP module 5U hosts the user plane part of the PDCP and the SDAP layers of the distributed gNB or the user plane part of the PDCP layer of the distributed En-gNB. If present, the gNB-DU module 5D hosts the RLC, MAC, and PHY layers of the distributed gNB or En-gNB.

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

Although not shown in FIG. 3, the base station 5 will also typically include an RRC module, a base station to base station interface module (e.g. X2/Xn), and a core network interface module.

The RRC module is operable to generate, send and receive signalling messages formatted according to the RRC standard. For example, such messages are exchanged between the base station 5 and the mobile device 3 (and other user equipment within the cell of the base station 5). The RRC messages may include, for example, messages relating to performing an RNAU procedure, as described above with reference to FIG. 12.

The base station to base station interface module is operable to generate, send and receive signalling messages (X2/Xn messages) formatted according to the X2AP (or XnAP) standard. The X2/Xn messages may include, for example, messages relating to paging a mobile device 3, data forwarding, transferring/fetching of UE context (and other information relating to the mobile device 3) between neighbouring base stations, and the CAG membership/subscription verification results in response to an RRCResumeRequest from a UE.

The core network interface module is operable to generate, send and receive signalling messages formatted according to the SlAP (or NG-C) standard. For example, such messages are exchanged between the base station 5 and the AMF/MME 13. The SlAP (or NG-C) messages may include, for example, messages relating to registering the location and/or operating state of user equipment in a cell of the base station 5, requesting paging for a particular mobile device 3, and/or associated responses, and/or the Registration procedure that may be triggered if a CAG membership/subscription verification process fails for a specified UE.

Core Network Node

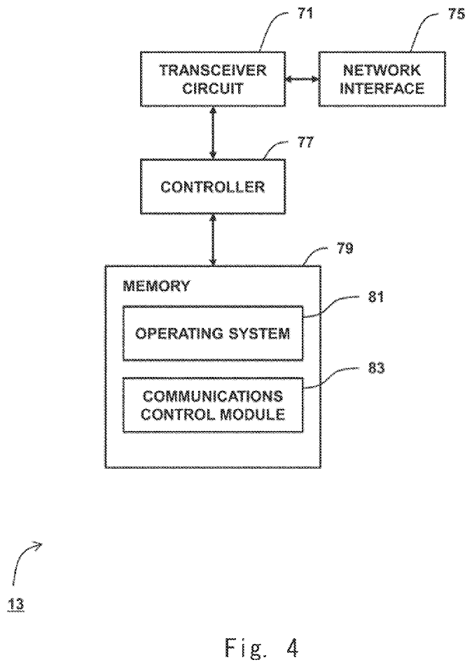

FIG. 4 is a block diagram illustrating the main components of a generic core network node (or function) shown in FIG. 1, for example, the AMF 13. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signalling between the core network node and other nodes, such as the UE 3, the (R)AN node 5, and other core network nodes. Such signalling includes appropriately formatted requests and responses relating to the Registration Procedure (or equivalent), as described above.

As explained above, in the current 5G architecture, for example, the gNB internal structure may be split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), PDCP) and the, typically ‘lower’, DU layers (for example, but not necessarily or exclusively, RLC/MAC/PHY) to be implemented separately. Thus, for example, the higher layer CU functionality for a number of gNBs may be implemented centrally (by a single unit), whilst retaining the lower layer DU functionality locally, in each of the gNB.

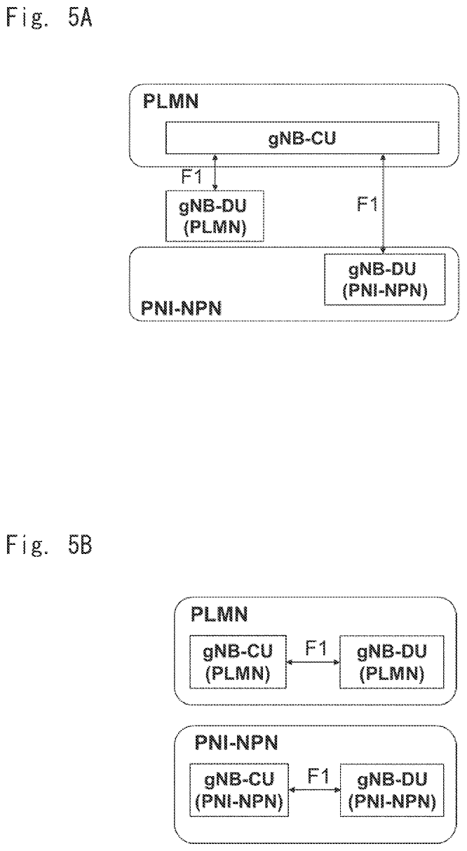

In the case of a PNI-NPN, the gNB-CU functionality for all of the gNBs in a network may be implemented and located in the same secure location, for example, as in a data centre or operator's building. With reference to FIGS. 5A and 5B, two typical deployment examples of this concept are illustrated. In FIG. 5A, the CU for the PNI-NPN gNB (located within the secure environment) is hosted with the support of a PLMN and shared with authorised gNBs outside of the PNI-NPN, using network slicing or CAG Access control. In FIG. 5B, the PNI-NPN is a standalone NPN, with the CU for the PNI-NPN gNB being implemented within the PNI-NPN, and without the support of a PLMN. Similarly, the CU for a gNB within the PLMN is hosted within that PLMN.

In both cases, the gNB-CU for the PNI-NPN is a centralised function, potentially serving multiple gNBs in the PNI-NPN; and, beneficially, CAG membership and access verification processes can be performed by the Central Unit, without the need for excessive additional signalling between the gNBs and the core network.

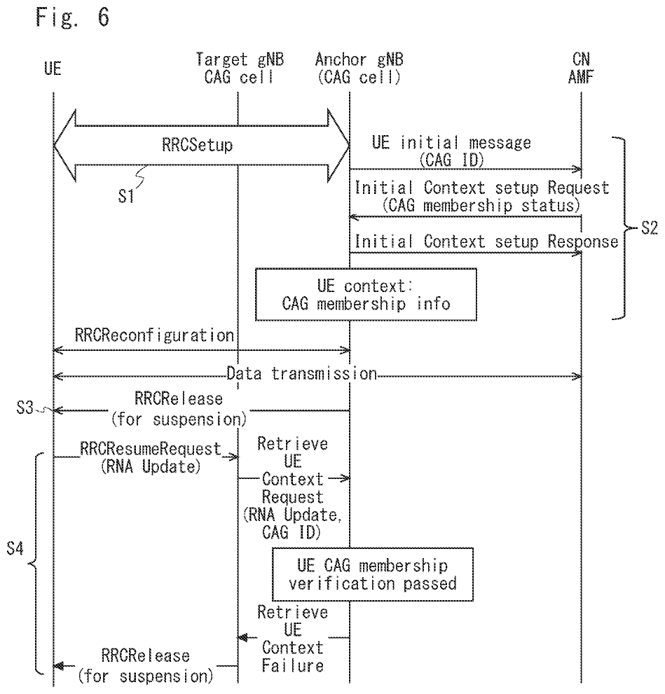

A more detailed description will now be given (with reference to FIGS. 6 to 11) of various ways in which a RAN based paging area can be configured for a mobile device (which may be operating in RRC INACTIVE state/mode).

There are a number of issues and considerations to be taken into account when the CAG membership/subscription verification process is performed by the base station (or a CU of a gNB), rather than the core network and, therefore, the system of FIG. 1 can be configured to take into account various scenarios, as set out below.

Operation—First Scenario

FIG. 6 is a timing diagram (message sequence chart) illustrating a first example process performed by the components of the system 1 when an anchor gNB, which is the gNB at which a UE initially accessed a CAG cell and which performed the initial Registration procedure) has the CAG membership information for a UE, and the UE initiates a periodic RNAU procedure at a target CAG cell having the same CAG Identifier.

Thus, at Step S1, the UE 3, using its communications control module 43, initially accesses a CAG cell having an associated CAG ID, and performs an appropriate RRC setup procedure via the base station 5 operating that initial cell. As part of the RRC setup procedure, the UE 3 transmits an RRCSetUp Request to the base station 5, which includes an appropriately formatted ‘UE Initial Message’. In this example, the UE's message includes at least one CAG identifier (CAG ID) associated with the UE 3 (e.g at least one CAG ID that corresponds to the CAG ID associated with the initial cell (hereinafter referred to as the ‘anchor’ cell).

At Step S2, the anchor base station 5 forwards the UE Initial Message (including the CAG ID) to the AMF 13 of the Core Network Node 7 and obtains CAG information (CAG verification information) indicating whether or not the UE 3 is authorised to use the NPN associated with the CAG to which the anchor cell belongs. If the information obtained from the core network 7/AMF 13 indicates that the UE 3 is not authorised to use that cell, then the base station rejects the UE's attempt to access the cell. If the information obtained from the Core Network Node 7/AMF 13 indicates that the UE 3 is authorised to use the cell, then the anchor base station and the UE 3 perform an appropriate RRC Reconfiguration procedure. After RRC Reconfiguration the UE 3 is able to transmit data towards the core network 7 via the CAG cell. The core network node 7/AMF 13 indicates in the UE context for the UE 3 that the UE 3 has been authorised to use the CAG/NPN associated with the initial cell (and possibly other CAGs/NPNs if the information obtained from the core network 7/AMF 13 indicates any other CAGs/NPNs associated with the UE 3). The UE Context provided to the anchor gNB includes this CAG membership information, and is stored in the memory 59 of the anchor base station (or the Central Unit thereof, in case of a distributed gNB).

Step S3: When the RRC connection is suspended, the UE 3 enters RRC inactive state (e.g. when it has no more data to send/receive). RRC suspension typically involves appropriate signalling (and/or a timer) between the network and the UE 3 so that the serving base station knows when the UE 3 has entered the RRC inactive state. The anchor base station stores the UE context for the inactive UE 3 so that the RRC connection can be resumed for periodic RNAU procedures, for example. It will be appreciated that the UE 3 may subsequently resume its suspended RRC connection either via a public cell or via a CAG cell having the same associated PLMN/CAG ID as the cell that the UE 3 has previously accessed.

At Step S4, If the UE 3 resumes its connection at another ‘target’ CAG cell having the same CAG ID, for the purposes of a periodic RNAU procedure, the target cell sends a ‘Retrieve UE Context Request’ message to the anchor base station 5, for the purpose of an RNA update, and including the CAG ID of the UE 3. The anchor base station 5 performs a membership verification process using the CAG ID included in the message and compares it with the membership information in the UE context data stored in its memory 59. In this case, the UE 3 CAG ID can be verified against the stored UE context and the anchor base station 5 returns a RetrieveUEContextFailure message which includes an encapsulated RRCRelease message. The RRCRelease message includes a Suspend Indication message, which acts as confirmation that the CAG ID matches the CAG ID of both the anchor base station 5 and the target base station and that the UE 3 is authorised to access the target base station. Therefore, the target base station sends the RRCRelease message to the UE 3, causing its RRC connection to be suspended. In this example, the UE Context data remains stored by the anchor base station 5, i.e. there is no context relocation.

Operation—Second Example

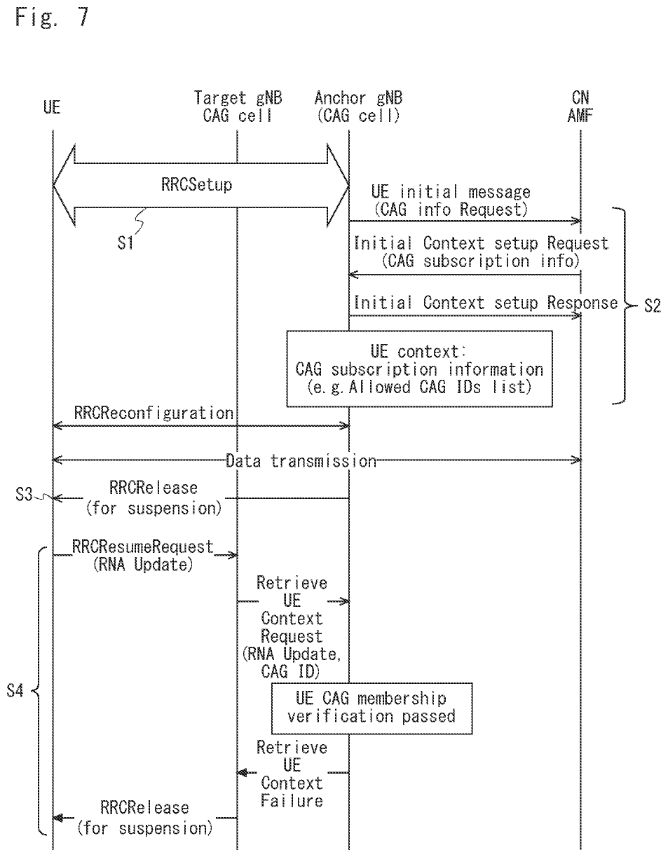

FIG. 7 is a timing diagram (message sequence chart) illustrating a second example process performed by the components of the system 1 when an anchor base station 5 (which is the base station 5 (gNB) at which a UE initially accessed a CAG cell and which performed the initial Registration procedure) has the CAG membership information for a UE 3, and the UE 3 initiates a periodic RNAU procedure at a target CAG cell having the same or different CAG Identifier.

In this case, at Step S1, the UE 3, using its communications control module 43, initially accesses a CAG cell having an associated CAG ID, and performs an appropriate RRC setup procedure via the base station 5 operating that initial cell. As part of the RRC setup procedure, the UE 3 transmits an RRC Setup Request to the base station 5, which includes an appropriately formatted ‘UE Initial Message’. In this example, the UE's message includes at least one CAG identifier (CAG ID) associated with the UE 3, which may not correspond to the CAG ID of the target cell.

At Step S2, the anchor base station 5 forwards the UE Initial Message (including an appropriately formatted request for UE specific CAG information) to the AMF 13 of the Core Network 7 and obtains CAG information (CAG subscription information, e.g. a list of CAG IDs of cells the UE 3 is permitted to access). The anchor base station 5 compares the received CAG ID for the UE 3 with the CAG subscription information received from the core network node 7 to determine whether or not the UE 3 is permitted to access the anchor cell (by checking whether the UE's CAG ID matches any of the entries in the relevant CAG subscription information). If the CAG subscription information obtained from the core network 7/AMF 13 indicates that the UE 3 is not authorised to use that cell, then the base station 5 rejects the UE's attempt to access the anchor cell. If the CAG subscription information obtained from the Core Network 7/AMF 13 indicates that the UE 3 is authorised to use the anchor cell, then the anchor base station and the UE 3 perform an appropriate RRC Reconfiguration procedure. After RRC Reconfiguration the UE 3 is able to communicate with the core network 7 (and other nodes beyond the core network 7) via the anchor CAG cell. The core network 7/AMF 13 indicates in the UE context for the UE 3 that the UE 3 has been authorised to use the CAG/NPN associated with the initial cell (and possibly other CAGs/NPNs if the information obtained from the core network 7/AMF 13 indicates any other CAGs/NPNs associated with the UE 3). The UE Context provided to the anchor base station 5 includes this CAG subscription information, and is stored in the memory 59 of the anchor base station 5 (or the memory associated with the Central Unit, in case of a distributed gNB).

Step S3: When the RRC connection is suspended, the UE 3 enters RRC inactive state (e.g. when it has no more data to send/receive). RRC suspension typically involves appropriate signalling (and/or a timer) between the network and the UE 3 so that the serving (anchor) base station 5 knows when the UE 3 has entered the RRC inactive state. The serving base station 5 stores the UE context for the inactive UE 3 so that the RRC connection can be resumed when appropriate (when there is more data for the UE 3 to send/receive).

At Step S4, If the UE 3 resumes its connection at another ‘target’ CAG cell having the same or a different CAG ID, for the purposes of a periodic RNAU procedure, the target cell sends (to the anchor base station) a ‘Retrieve UE Context Request’ message, for the purpose of an RNA update, and including the CAG ID of the UE 3. The anchor base station 5 performs a membership verification process based on the CAG ID included in the UE's message and compares it with the membership subscription information in the UE context. In this case, the UE 3 CAG ID can be verified against the stored UE context and the anchor base station 5 returns a RetrieveUEContextFailure message which includes an encapsulated RRCRelease message. When the target gNB receives the RetrieveUEContextFailure message, it considers the reception of this message as an implicit indication that the UE has passed the CAG verification, so the target gNB proceeds forward to the RRCRelease message to the UE, causing its RRC connection to be suspended. In this example, the UE Context data (including the CAG membership subscription data for that UE 3) remains stored at the anchor base station 5, i.e. there is no context relocation.

Operation—Third Example

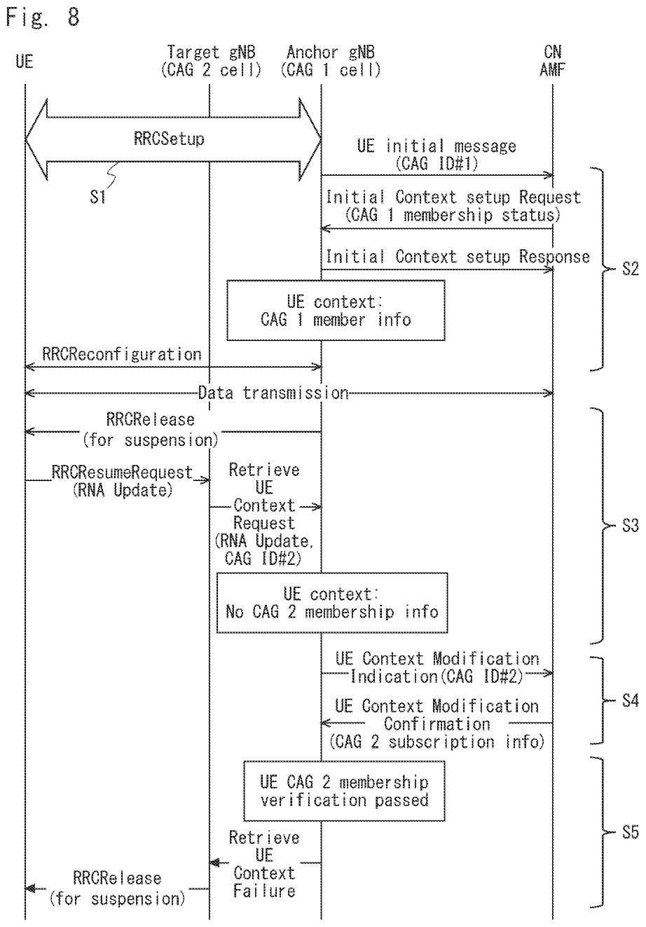

FIG. 8 is a timing diagram (message sequence chart) illustrating a third example process performed by the components of the system 1 when an anchor base station 5, which is the base station at which a UE initially accessed a CAG cell (and which performed the initial Registration procedure) has the CAG membership information for a UE 3, and the UE 3 initiates a RNAU procedure at a target CAG cell having a different CAG Identifier.

In this case, at Step S1, the UE 3, using its communications control module 43, initially accesses a CAG cell having an associated CAG ID #1, and performs an appropriate RRC setup procedure (which includes an appropriately formatted ‘UE Initial Message’) via the base station operating that initial cell. In this example, the UE's message includes at least one CAG identifier (CAG ID #1) associated with the UE 3, which corresponds to the CAG ID of (the cell of) the anchor base station 5.

At Step S2, the anchor base station 5 forwards the UE Initial Message (including the CAG ID #1) to the AMF 13/Core Network 7 and obtains CAG information (CAG verification information/CAG membership information) indicating whether or not the UE 3 is authorised to use the NPN associated with the CAG to which the anchor cell belongs (i.e. CAG #1). If the information obtained from the core network 7/AMF 13 indicates that the UE 3 is not authorised to use that cell, then the base station rejects the UE's attempt to access the cell. If the information obtained from the Core Network 7/AMF 13 indicates that the UE 3 is authorised to use the cell, then the anchor base station 5 and the UE 3 perform an appropriate RRC Reconfiguration procedure. After RRC Reconfiguration the UE 3 is able to communicate with the core network 7 via the CAG 1 cell. The core network node 7/AMF 13 indicates in the UE context for the UE 3 that the UE 3 has been authorised to use the CAG/NPN associated with the initial cell, i.e. CAG 1, and possibly other CAGs/NPNs if the information obtained from the core network 7/AMF 13 indicates any other CAGs/NPNs associated with the UE 3). The UE Context provided to the anchor base station 5 includes this CAG membership information, and is stored in the memory 59 of the anchor base station 5.

Step S3: When the RRC connection is suspended, the UE 3 enters RRC inactive state (e.g. when it has no more data to send/receive). RRC suspension typically involves appropriate signalling (and/or a timer) between the network and the UE 3 so that the serving base station knows when the UE 3 has entered the RRC inactive state. The anchor base station 5 stores the UE context for the inactive UE 3 so that the RRC connection can be resumed for periodic RNAU procedures, for example. It will be appreciated that the UE 3 may subsequently resume its suspended RRC connection either via a public cell or via a CAG cell.

In this case, the UE 3 resumes its connection at another ‘target’ CAG cell having a different CAG ID (CAG ID #2), for the purposes of a RNAU procedure. The target cell sends a ‘Retrieve UE Context Request’ message to the anchor base station 5, in order to fetch the UE context associated with the UE 3. In this case, the message from the target base station includes the CAG ID #2 (associated with the cell at which the UE 3 attempts to resume its RRC connection). The anchor base station 5 performs a membership verification process using the CAG ID #2 included in the message and compares it with the membership information in the UE context data stored in its memory 59. In this case, the UE 3 CAG ID #2 cannot be verified against the stored UE context as the anchor base station 5 does not have the relevant CAG #2 data for the UE 3.

Thus, at Step S4, the anchor base station 5 requests (from the core network 7/AMF 13) the CAG 2 information by means of a UE ContextModification message which indicates to the AMF 13 that the UE 3 is attempting to access a CAG 2 cell. The AMF 13 performs a membership verification process for the UE 3 in relation to CAG ID #2 and returns a verification result. If the UE 3 is not permitted to access a CAG 2 then the base station rejects the UE's attempt to access the cell. However, if the UE 3 is permitted to access the CAG 2 cell, the AMF 13 returns (to the anchor base station 5) a message confirming that the stored UE Context information for the UE 3 can be modified to include CAG ID #2, and provides CAG 2 subscription information for storage (by the anchor base station 5) with the UE context information for the UE 3.

At step S5, and in the case that the CAG 2 membership verification for the UE3 has been successful, the anchor base station 5 returns a RetrieveUEContextFailure message to the target base station which includes an encapsulated RRCRelease message. The RRCRelease message includes a Suspend Indication message, which acts as confirmation that the UE3 is permitted to access a CAG 2 cell. Therefore, the target base station sends the RRCRelease message to the UE 3, causing its RRC connection to be suspended. In this example, the UE Context data (including the new CAG 2 information) remains stored by the anchor base station 5, i.e. there is no context relocation.

All of the above examples illustrate CAG verification processes in the case where there is no UE context relocation, i.e. the UE context information (including any CAG membership/subscription information) remains stored by the anchor base station 5 (i.e. the base station that was used for the initial Registration (RRC Setup) procedure.

It will be appreciated that, in all of the above examples, the concept of UE Context relocation could be incorporated. UE Context Relocation will be well known to a person skilled in the art in relation to RRC. However, in this case, the CAG membership verification steps may include the step of sending the UE Context, including CAG membership subscription information for the UE 3, to the target base station (for storage in its memory until the next Resume Request) each time the UE 3 accesses a cell that is not the last serving cell. In other words, in these scenarios, the last serving cell would perform the CAG membership verification processes described above.

Operation—Fourth Example

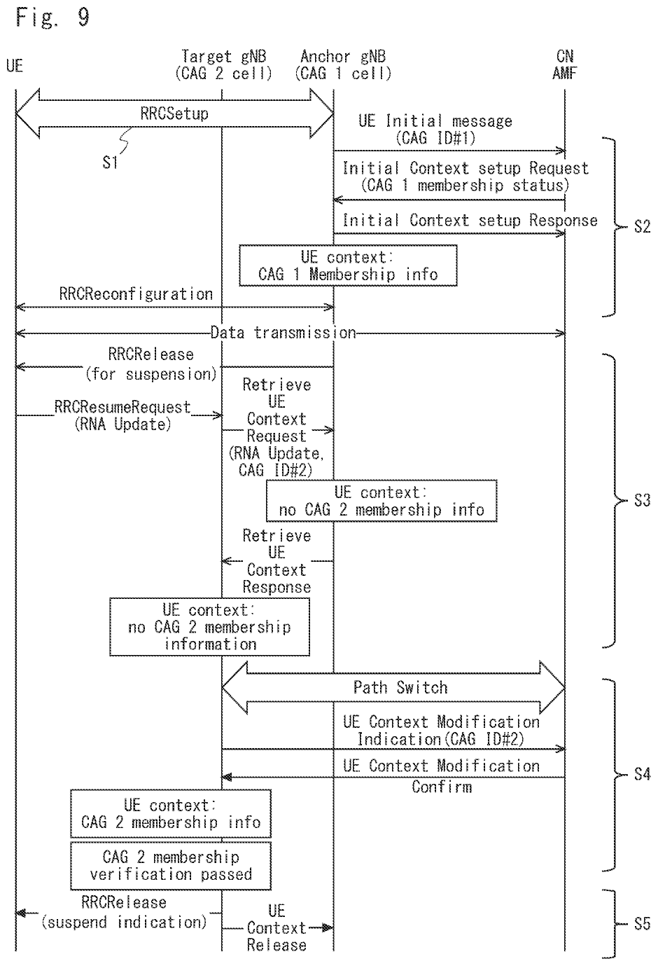

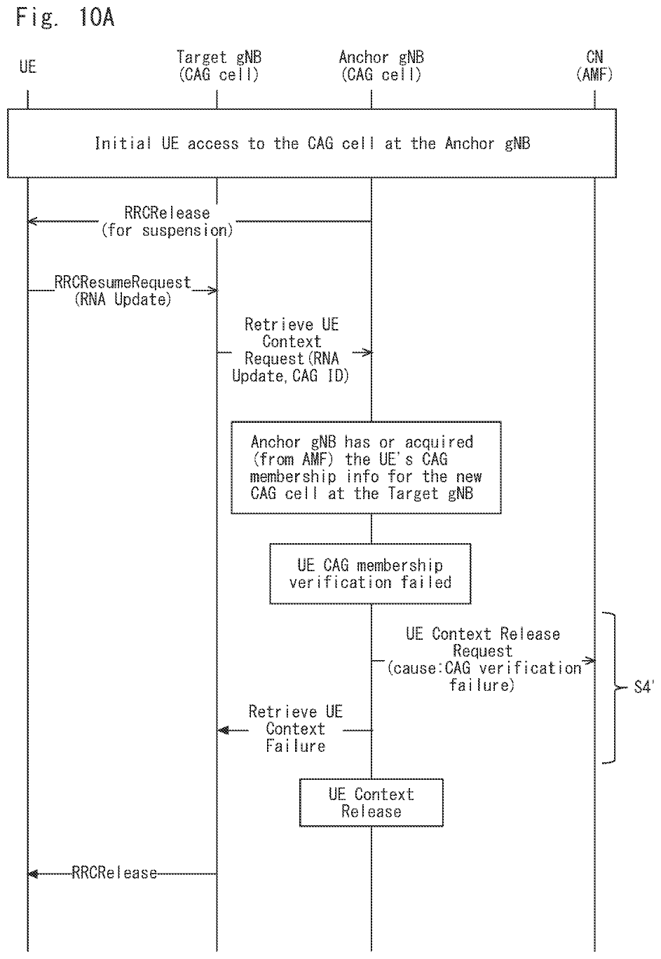

FIG. 9 is a timing diagram (message sequence chart) illustrating an example process performed by components of the system 1 in the case where UE Context Relocation is incorporated and the last serving base station 5 has the CAG Membership/Subscription information for the UE 3.

In this case, at Step S1, the UE 3, using its communications control module 43, initially accesses a CAG cell having an associated CAG ID #1, and performs an appropriate RRC setup procedure (during which the UE 3 transmits an appropriately formatted ‘UE Initial Message’) via the base station 5 operating that initial cell. In this example, the ‘UE Initial Message’ includes at least one CAG identifier (CAG ID #1) associated with the UE 3, which corresponds to the CAG ID of the (anchor) base station 5.

At Step S2, the anchor base station 5 forwards the UE Initial Message (including the CAG ID) to the AMF 13 (or another core network node) and obtains CAG information (CAG verification information) indicating whether or not the UE 3 is authorised to use the CAG cell having the identifier CAG ID #1. If the information obtained from the core network 7/AMF 13 indicates that the UE 3 is not authorised to use that cell, then the base station rejects the UE's attempt to access the cell. If the information obtained from the Core Network 7/AMF 13 indicates that the UE 3 is authorised to use the cell, then the anchor base station 5 and the UE 3 perform an appropriate RRC Reconfiguration procedure. After RRC Reconfiguration the UE 3 is able to transmit data towards the core network 7 via the CAG cell. The core network 7/AMF 13 indicates in the UE context for the UE 3 that the UE 3 has been authorised to use the CAG/NPN associated with the initial cell, i.e. CAG #1. The UE Context provided to the anchor base station 5 includes this CAG #1 membership information for the UE 3, and it is stored in the memory 59 of the anchor base station 5.

When the RRC connection is suspended, the UE 3 enters RRC inactive state (e.g. when it has no more data to send/receive). RRC suspension typically involves appropriate signalling (and/or a timer) between the network and the UE 3 so that the anchor base station 5 knows when the UE 3 has entered the RRC inactive state. The anchor base station 5 stores the UE context for the inactive UE 3 so that the RRC connection can be resumed when appropriate (when there is more data for the UE 3 to send/receive). It will be appreciated that the UE 3 may subsequently resume its suspended RRC connection either via a public cell or via a CAG cell having the same or a different associated PLMN/CAG ID as the cell that the UE 3 has previously accessed.

As generally shown in Step S3, in this case the UE 3 resumes its connection at another ‘target’ CAG cell having a different CAG ID (CAG ID #2), for the purposes of a RNAU procedure. The base station operating the target cell sends (to the anchor base station 5) a ‘Retrieve UE Context Request’ message, in order to obtain the UE context for this UE 3. The Retrieve UE Context Request message includes the CAG ID #2 and indicates that the purpose of resuming the RRC connection is RNA update. It will be appreciated that, in the meantime, other periodic RNAU procedures and/or other Resume events may have been initiated and performed by the UE 3 and, if the base stations 5 in the network are configured to incorporate UE Context Relocation, the up-to-date UE Context information including any CAG Membership information for the UE 3 may be stored at the base station serving the UE's most recently visited cell, rather than the above described (first) anchor base station 5.

In response to the Retrieve UE Context Request message, the anchor base station 5 performs a membership verification process using the CAG ID #2 included in the message and compares it with the membership information in the UE context data stored in its memory 59. In this case, the UE 3 CAG ID #2 cannot be verified against the stored UE context as the anchor base station 5 does not have the relevant CAG #2 data for the UE 3. So, even though the UE 3 may have membership for the PLMN associated with the CAG #2 cell, the UE context information at the anchor base station 5 does not indicate this. Accordingly, the anchor base station 5 determines based on its UE Context information that it has no CAG #2 membership information for this UE 3 and returns a Retrieve UE Context Response message to the target base station to indicate the same. In this case, the UE context is being relocated to the target base station, i.e. the Retrieve UE Context Response message includes the UE Context and any CAG information included therein (in this example, CAG #1 membership information).

Thus, at Step 4, the target gNB requests (from the core network 7/AMF 13) information identifying whether the UE 3 is allowed access to cells having CAG ID #2 by means of a UE ContextModification message which indicates to the AMF 13 that the UE 3 is attempting to access a CAG #2 cell. The AMF 13 performs a membership verification process for the UE 3 in relation to CAG ID #2 and returns a verification result. If the UE 3 is not permitted to access CAG #2 cells then the target base station 5 rejects the UE's attempt to access the cell. However, if the UE 3 is permitted to access the CAG #2 cell, the AMF 13 returns (to the target base station 5) a message confirming this allowing the base station 5 to update the stored UE Context information for the UE 3 to include CAG ID #2. The base station 5 determines that CAG verification with respect to CAG ID #2 has been successful for the UE 3.

At step 5, and in the case that the CAG #2 membership verification for the UE3 has been successful, the target gNB sends an appropriate RRCRelease message to the UE 3, causing its RRC connection to be suspended. In this example, the updated UE Context data (including the new CAG #2 information) remains stored in the memory 59 of the target base station 5 (e.g. in addition to any other previously verified CAG membership information such as CAG #1).

Operation—CAG Membership Failure

There are two potential reasons why membership verification for a UE may ultimately fail, irrespective of which of the processes above are used. These are:
The membership conditions for the UE have changed whilst it is in the inactive mode; or
The UE is a fraud UE and is not permitted to access the network.

In the following examples, various scenarios are considered in relation to membership verification failure. In relation to the first, second and third examples described above (i.e. the case where RRC resumption/RNA update is performed without Context Relocation and the anchor gNB retains the UE Context information, the following two example options are envisaged.

A first option could include the anchor base station sending, to the target base station, the RETRIEVE UE CONTEXT FAILURE message including a new clause value (e.g. CAG membership failure) and an encapsulated RRC Release message. The anchor base station then releases the UE Context and the target base station sends the RRCRelease message to the UE to transition it to the RRC_IDLE mode described above.

Another option could include the anchor base station sending, to the target base station, the RETRIEVE UE CONTEXT FAILURE message including an encapsulated RRCRelease message (but not a new cause value) and then release the UE context. The target base station then sends the RRCRelease message to the UE to transition it into the RRC_IDLE mode described above.

In relation to the fourth example described above, where the RRC includes Context Relocation, the target base station can simply move the UE to the RRC_IDLE mode when the UE context is updated to indicate that the membership verification process for the UE failed.

The options proposed above do not consider the issue of informing the AMF that a specified UE has tried to access a CAG cell and the membership verification has failed. It may be advantageous to inform the AMF of every unsuccessful access attempt in relation to a PNI-NPN so that they can be further investigated and malicious attacks can be monitored.

The following examples relate to respective processes for handling CAG verification failure and informing the AMF of such failures.

Operation—Fifth Example

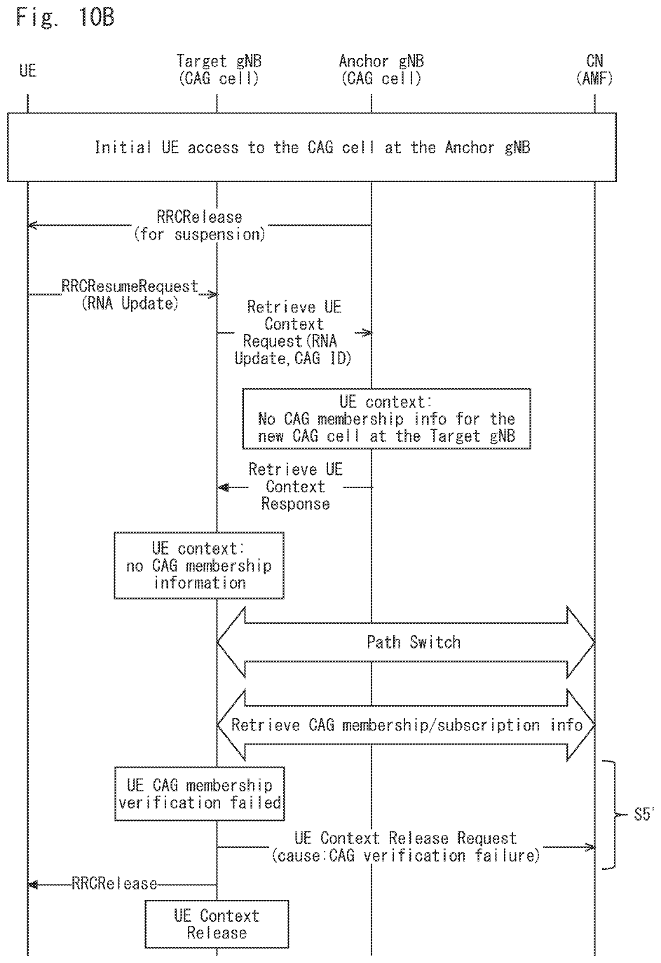

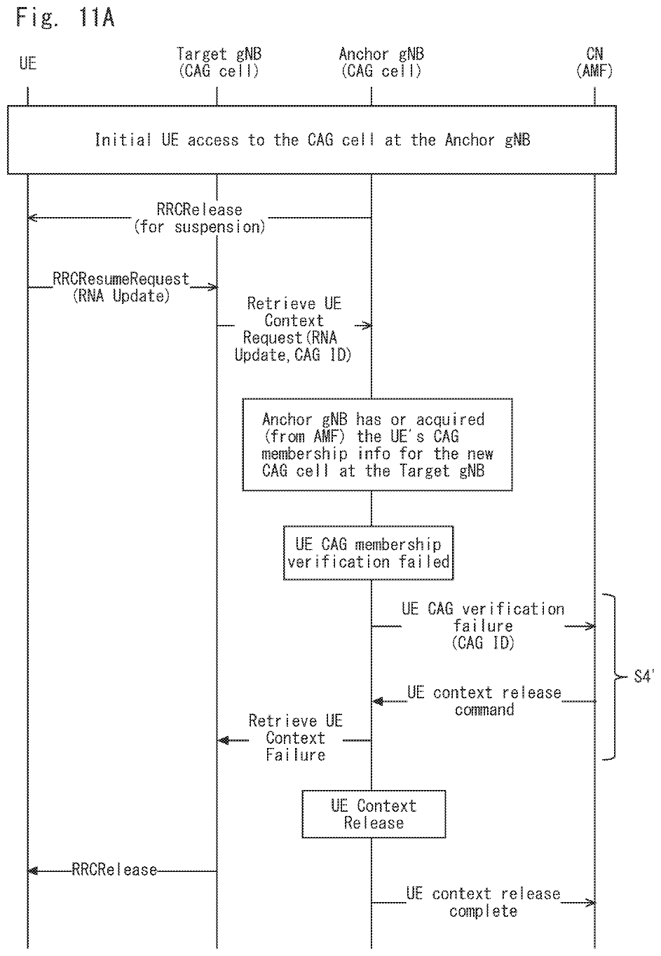

FIG. 10A is a timing diagram (message sequence chart) illustrating an example process performed by components of the system 1, which is relevant to the first, second and third examples above (i.e. RRC resumption/RNA update is performed without UE Context Relocation). In this case, CAG membership verification is performed by the anchor base station 5. As shown, at step S4′, in the event that the membership verification process fails for the UE 3 (for the CAG ID indicated by the target base station 5)), the anchor base station 5 sends to the core network 7 (e.g. the AMF 13) an appropriately formatted message (e.g. a UEContextRelease request) including an appropriate cause value indicating this verification failure (e.g. a ‘CAG verification failure’ cause value and/or the like). It will be appreciated that the message may also include information identifying the UE 3 and/or the cell of the target base station 5 that the UE 3 attempted to access. The anchor base station 5 also informs the target base station 5 about the verification failure (e.g. by sending a UEContextFailure message).

Operation—Sixth Example

FIG. 10B is a timing diagram (message sequence chart) illustrating an example process performed by components of the system 1, which is relevant to the fourth example described above (i.e. RRC resumption/RNA update is performed with UE Context Relocation). In this case, CAG membership verification is performed by the target base station 5. As shown, at Step 5′, in the event that the membership verification process fails for the UE 3, the target base station 5 sends, to the core network 7 (e.g. the AMF 13), an appropriately formatted message (e.g. a UEContextRelease request) including an appropriate cause value indicating this verification failure (e.g. a ‘CAG verification failure’ cause value and/or the like). It will be appreciated that the message may also include information identifying the UE 3 and/or the cell of the target base station that the UE 3 attempted to access. The target base station 5 also generates and sends an RRCRelease message to the UE 3 to transition it to RRC_IDLE mode.

Operation—Seventh Example

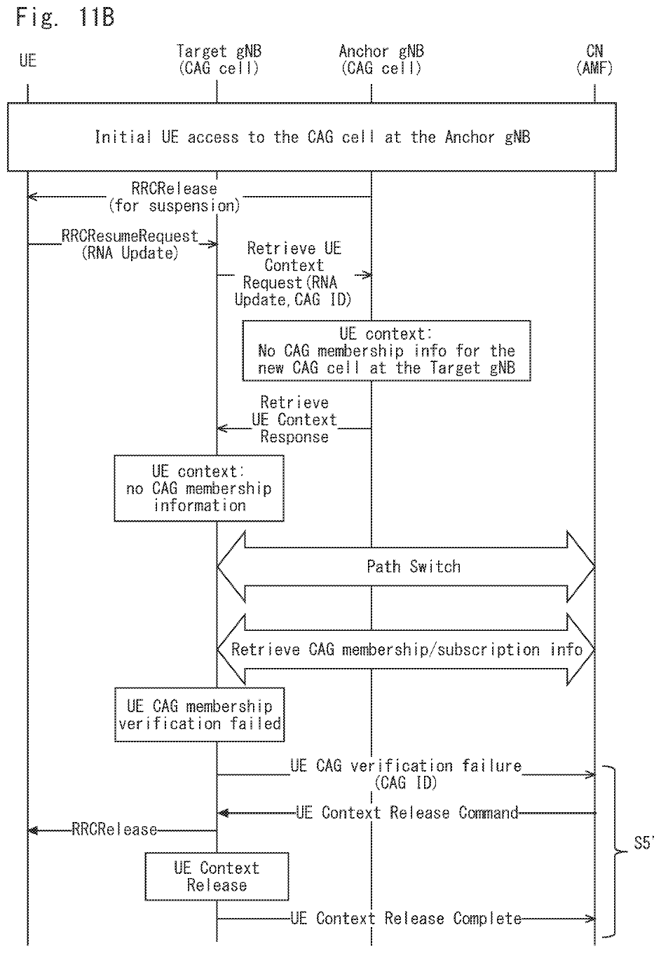

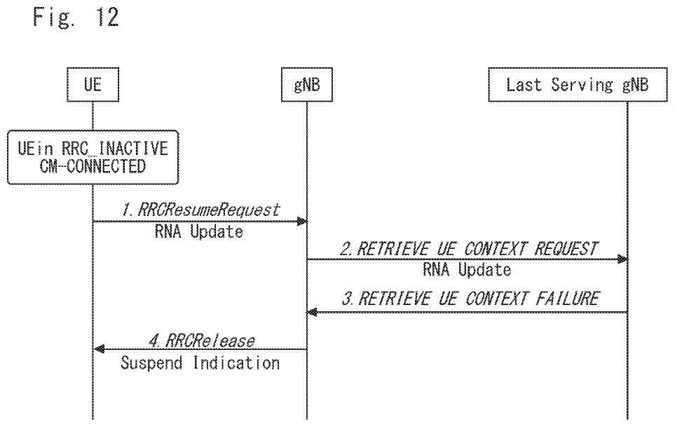

FIG. 11A is a timing diagram (message sequence chart) illustrating an example process performed by the components of the system 1, which is relevant to the first, second and third examples described above (i.e. RRC resumption/RNA update is performed without UE Context Relocation). The message sequence is similar in most respects to that of FIG. 10A, except that, at step S4′, instead of indicating the CAG verification failure by means of a cause value via a UEContextRelease Request message (and/or the like), CAG verification failure is indicated to the core network 7 by means of a Class 2 message (i.e. a message or notification that does not require a response). Specifically, in this example, the anchor base station 5 generates and sends a ‘UE CAG verification failure’ message and includes in this message information identifying the CAD ID that failed. It will be appreciated that the message may also include information identifying the UE 3 and/or the cell of the target base station that the UE 3 attempted to access.

Operation—Eighth Example

FIG. 11B is a timing diagram (message sequence) chart illustrating an example process performed by the components of system 1, which is relevant to the fourth example described above (i.e. RRC resumption/RNA update is performed with UE Context Relocation). In this case, CAG membership verification is performed by the target base station 5. The message sequence is similar in most respects to that of FIG. 10B, except that, at step S5′, the target base station 5 informs the core network 7 about the CAG verification failure by means of a Class 2 message. Specifically, in this example, the target base station 5 generates and sends a ‘UE CAG verification failure’ message and includes in this message information identifying the CAD ID that failed. It will be appreciated that the message may also include information identifying the UE 3 and/or the cell of the target base station that the UE 3 attempted to access.

Modifications and Alternatives

Detailed embodiments have been described above. As those skilled in the art will appreciate, a number of modifications and alternatives can be made to the above embodiments whilst still benefiting from the disclosure embodied therein. By way of illustration only a number of these alternatives and modifications will now be described.

In the above description, the UE, the (R)AN node, and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch eXchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

Part of or all the foregoing embodiments can be described as in the following appendixes, but the present disclosure is not limited thereto.

(Supplementary Note 1)

A method performed by a base station in a Non-Public communication Network in which the base station operates at least one closed access group (CAG) cell, the method comprising:

forming a communications connection with a user equipment (UE) in a CAG cell operated by the base station, wherein the CAG cell is associated with a CAG having an associated CAG identifier;

releasing the communications connection for suspension of the connection at the UE;

receiving, from a further base station, a message indicating that the UE has requested resumption of the communication connection in a CAG cell operated by the further base station, the message comprising a CAG identifier of a CAG with which the cell operated by the further base station is associated;

performing CAG membership verification for the CAG identified by the CAG identifier provided in the message indicating that the UE has requested resumption of the communication connection; and

sending a message to the further base station indicating a result of said CAG membership verification.

(Supplementary Note 2)

The method according to Supplementary Note 1, wherein the CAG cell operated by said base station and the CAG cell operated by the further base station are both associated with the same CAG.

(Supplementary Note 3)

The method according to Supplementary Note 1 or 2, further comprising obtaining, before releasing the communications connection for suspension of the connection at the UE, CAG membership information for the CAG associated with the CAG cell operated by that base station, and wherein the CAG membership verification is performed based on the CAG membership information.

(Supplementary Note 4)

The method according to Supplementary Note 1 or 2, further comprising obtaining, before releasing the communications connection for suspension of the connection at the UE, CAG subscription information for the CAG associated with the CAG cell operated by that base station, and wherein the CAG membership verification is performed based on the CAG subscription information.

(Supplementary Note 5)

The method according to Supplementary Note 4, wherein the subscription information identifies a plurality of CAGs that the UE is allowed to access.

(Supplementary Note 6)

The method according to Supplementary Note 1, wherein the CAG cell operated by said base station and the CAG cell operated by the further base station are associated with different CAGs.

(Supplementary Note 7)

The method according to Supplementary Note 6, further comprising obtaining, after receipt of said message indicating that the UE has requested resumption of the communication connection in a CAG cell operated by the further base station, CAG subscription information for the CAG associated with the CAG cell operated by the further base station based on the CAG identifier in said message indicating that the UE has requested resumption of the communication connection, and wherein the CAG membership verification is performed based on the obtained CAG subscription information.

(Supplementary Note 8)

The method according to any of Supplementary Notes 1 to 7, wherein when the CAG membership verification fails, the method further comprises notifying a core network function of the failure.

(Supplementary Note 9)

The method according to Supplementary Note 8, wherein said notifying a core network function of the failure comprises sending, to the core network function, a UE context release request message with a cause information element set to indicate the cause of the UE context release request to be CAG verification failure.

(Supplementary Note 10)

The method according to Supplementary Note 8, wherein said notifying a core network function of the failure comprises sending, to the core network function, a dedicated class 2 message for indicating the CAG verification failure.

(Supplementary Note 11)

The method according to any of Supplementary Notes 1 to 7, wherein when the CAG membership verification fails, a retrieve UE context failure message is sent to the further base station comprising a cause information element set to indicate the cause of the UE context release request to be CAG verification failure.

(Supplementary Note 12)

The method according to any of Supplementary Notes 1 to 7, wherein when the CAG membership verification fails, the message sent to the further base station indicating a result of said CAG membership verification comprises an RRC release message.

(Supplementary Note 13)

The method according to any of Supplementary Notes 1 to 10, wherein the message indicating that the UE has requested resumption of the communication connection is configured to indicate that the requested resumption is for the purpose of a radio access network (RAN) based notification area (RNA) update.

(Supplementary Note 14)

A method performed by a base station in a Non-Public communication Network in which the base station operates at least one closed access group (CAG) cell, the method comprising:

receiving, from a user equipment (UE) in a CAG cell operated by the base station, wherein the CAG cell is associated with a CAG having an associated CAG identifier, a message for resumption of a communication connection suspended in a CAG cell operated by another base station;

obtaining, from said another base station or from a core network function, CAG membership information for the CAG associated with the CAG cell operated by that base station; and

performing CAG membership verification for the CAG identifier based on the obtained CAG membership information.

(Supplementary Note 15)

The method according to Supplementary Note 14, wherein when the CAG membership verification fails, the method further comprises notifying a core network function of the failure.

(Supplementary Note 16)

The method according to Supplementary Note 15, wherein said notifying a core network function of the failure comprises sending, to the core network function, a UE context release request message with a cause information element set to indicate the cause of the UE context release request to be CAG verification failure.

(Supplementary Note 17)

The method according to Supplementary Note 15, wherein said notifying a core network function of the failure comprises sending, to the core network function, a dedicated class 2 message for indicating the CAG verification failure.

(Supplementary Note 18)

The method according to Supplementary Note 14, wherein when the CAG membership verification fails, the base station moves the UE to RRC_IDLE.

(Supplementary Note 19)

A base station for a Non-Public communication Network in which the base station operates at least one closed access group (CAG) cell, the base station comprising a controller and a transceiver wherein the controller is configured: to control the transceiver in the formation of a communications connection with a user equipment (UE) in a CAG cell operated by the base station, wherein the CAG cell is associated with a CAG having an associated CAG identifier; to control the transceiver to release the communications connection for suspension of the connection at the UE; to control the transceiver receive, from a further base station, a message indicating that the UE has requested resumption of the communication connection in a CAG cell operated by the further base station, the message comprising a CAG identifier of a CAG with which the cell operated by the further base station is associated; to perform CAG membership verification for the CAG identified by the CAG identifier provided in the message indicating that the UE has requested resumption of the communication connection; and to control the transceiver to send a message to the further base station indicating a result of said CAG membership verification.

(Supplementary Note 20)

A base station for a Non-Public communication Network in which the base station operates at least one closed access group (CAG) cell, the base station comprising a controller and a transceiver wherein the controller is configured: to control the transceiver to receive, from a user equipment (UE) in a CAG cell operated by the base station, wherein the CAG cell is associated with a CAG having an associated CAG identifier, a message for resumption of a communication connection suspended in a CAG cell operated by another base station; to control the transceiver to obtain, from said another base station or from a core network function, CAG membership information for the CAG associated with the CAG cell operated by that base station; and to performing CAG membership verification for the CAG identifier based on the obtained CAG membership information.

It will be appreciated by a person skilled in the art that numerous variations and/or modifications may be made to the present disclosure as shown in the specific embodiments without departing from the spirit or scope of this disclosure as broadly described. The present embodiments are, therefore, to be considered in all respects to be illustrative and not restrictive.

This application is based upon and claims the benefit of priority from United Kingdom patent application No. 1914404.7, filed on Oct. 4, 2019, the disclosure of which is incorporated herein in its entirety by reference.

### REFERENCE SIGNS LIST

1 mobile telecommunication system
3 mobile device (UE)
5 base station
5C gNB-CU-CP module
5U gNB-CU-UP module
5D gNB-DU module
7 core network
11 Control Plane Function (CPF)
12 User Plane Function (UPF)
13 Access and Mobility Management Function (AMF)
20 external IP network
31 transceiver circuit
33 antenna
35 user interface
37 controller
39 memory
41 operating system
43 communications control module
45 paging module
46 RRC module
49 NAS module
51 transceiver circuit
53 antenna
55 network interface
57 controller
59 memory
61 operating system
63 communications control module
71 transceiver circuit
75 network interface
77 controller
79 memory
81 operating system
83 communications control module

What is claimed is:

1. A method performed by a base station in a Non-Public Network, the method comprising:
operating a closed access group (CAG) cell;
establishing a communication connection with a user equipment (UE) in the CAG cell, wherein the CAG cell is associated with a CAG having an associated CAG identifier;
suspending the communication connection;
receiving, from a further base station, a first message indicating that the UE has requested resumption of the communication connection in a CAG cell operated by the further base station, the first message including a CAG identifier of a CAG which the CAG cell operated by the further base station is associated with;
performing CAG membership verification for the CAG identified by the CAG identifier in the first message; and
sending, to the further base station, a second message indicating a result of the CAG membership verification.

2. The method according to claim 1, wherein the CAG cell operated by the base station and the CAG cell operated by the further base station are both associated with the same CAG.

3. The method according to claim 1, further comprising:
obtaining, before suspending the communication connection, CAG membership information for the CAG associated with the CAG cell operated by the further base station, and wherein
the performing the CAG membership verification is performed based on the CAG membership information.

4. The method according to claim 1, further comprising:
obtaining, before suspending the communication connection, CAG subscription information for the CAG associated with the CAG cell operated by that the further base station, and wherein
the performing the CAG membership verification is performed based on the CAG subscription information.

5. The method according to claim 4, wherein the CAG subscription information identifies a plurality of CAGs that the UE is allowed to access.

6. The method according to claim 1, wherein the CAG cell operated by the base station and the CAG cell operated by the further base station are associated with different CAGs.

7. The method according to claim 6, further comprising:
obtaining, after receipt of the first message, CAG subscription information for the CAG associated with the CAG cell operated by the further base station based on the CAG identifier in the first message, and wherein
the performing the CAG membership verification is performed based on the CAG subscription information.

8. The method according to claim 1, further comprising:
notifying a core network function of the failure in a case where the CAG membership verification fails.

9. The method according to claim 8, wherein the notifying the core network function of the failure includes sending, to the core network function, a UE context release request message including a cause information element set to CAG membership verification failure.

10. The method according to claim 8, wherein the notifying the core network function of the failure includes sending, to the core network function, a dedicated class 2 message for indicating the CAG membership verification failure.

11. The method according to claim 1, further comprising sending, to the further base station, a retrieve UE context failure message including a cause information element set to CAG verification failure, in a case where the CAG membership verification fails.

12. The method according to claim 1, wherein the first message includes a Radio Resource Control (RRC) release message.

13. The method according to claim 1, wherein the first message is configured to indicate that the requested resumption is for the purpose of a radio access network (RAN) based notification area (RNA) update.

14. A method performed by a base station in a Non-Public Network, the method comprising:
operating a closed access group (CAG) associated with a CAG having an associated CAG identifier;
receiving, from a user equipment (UE) in the CAG cell a third message for resumption of a communication connection suspended in a CAG cell operated by a further base station;
sending, to the further base station or a core network function, a first message indicating that the UE has requested resumption of the communication connection, the first message including the CAG identifier; and
receiving, from the further base station or the core network function, a second message indicating a result of CAG membership verification for the CAG identified by the CAG identifier in the first message, the CAG membership verification being performed by the further base station or the core network function.

15. The method according to claim 14, further comprising:
notifying the core network function of a failure in a case where the CAG membership verification fails.

16. The method according to claim 15, wherein the notifying the core network function of the failure includes sending, to the core network function, a UE context release request message including a cause information element set to CAG membership verification failure.

17. The method according to claim 15, wherein the notifying the core network function of the failure includes sending, to the core network function, a dedicated class 2 message for indicating the CAG membership verification failure.

18. The method according to claim 14, further comprising:
moving the UE to RRC IDLE in a case where the CAG membership verification fails.

19. A base station for a Non-Public Network, the base station comprising:
a controller; and
a transceiver, wherein the controller is configured:
to operate a closed access group (CAG) cell;
to control the transceiver to establish a communication connection with a user equipment (UE) in the CAG cell, wherein the CAG cell is associated with a CAG having an associated CAG identifier;
to control the transceiver to suspend the communication connection;
to control the transceiver to receive, from a further base station, a first message indicating that the UE has requested resumption of the communication connection in a CAG cell operated by the further base station, the message including a CAG identifier of a CAG which the CAG cell operated by the further base station is associated with;
to perform CAG membership verification for the CAG identified by the CAG identifier first message; and
to control the transceiver to send, to the further base station, a further message indicating a result of the CAG membership verification.

20. A base station for a Non-Public Network, the base station comprising:
a controller; and
a transceiver, wherein the controller is configured:
to operate at least one closed access group (CAG) associated with a CAG having an associated CAG identifier;
to control the transceiver to receive, from a user equipment (UE) in the CAG cell, a third message for resumption of a communication connection suspended in a CAG cell operated by a further base station;
to control the transceiver to send, to the further base station or a core network function, a first message indicating that the UE has requested resumption of the communication connection, the first message including the CAG identifier; and
to control the transceiver to receive, from the further base station or the core network function, a second message indicating a result of CAG membership verification for the CAG identified by the CAG identifier in the first message, the CAG membership verification being performed by the further base station or the core network function.
